(19) United States
(12) Patent Application Publication
(10) Pub. No.: US 2025/0045703 A1
(43) Pub. Date: Feb. 6, 2025

(54) Calendar Management

(71) Applicant: Bhupinder Sethi, REDMOND, WA (US)

(72) Inventor: Bhupinder Sethi, REDMOND, WA (US)

(21) Appl. No.: 18/363,373

(22) Filed: Aug. 1, 2023

(51) Int. Cl. G06Q 10/109; H04L 51/046

(52) U.S. Cl. CPC G06Q 10/109; H04L 51/046

(57) ABSTRACT

Calendar management may allow scheduling, moving, or canceling appointments with incomplete information. It may use a chat-based conversational interface, natural language processing, a voice-based interface, a hybrid of chat and voice, or a display-based menu interface, for example.

### FIELD

This disclosure relates generally to calendar management.

### BACKGROUND

Calendar management tools have evolved over time, from paper planners to computer-based calendars to online scheduling. Current calendar software allows users to view and manage their appointments, including invitations and appointment details, with multiple views such as day, week, and month. But the software paradigm has remained unchanged for over a decade.

Schedule organizers and calendaring software have a long history. Before computers, people often used paper planners, which became popular in America after the Civil War. With the advent of technology, calendars became available on computers. Today, calendar software is not only used by individuals to manage personal calendars but also used by companies and teams to allow customers or partners to schedule time with them. Online scheduling has been shown to minimize no-shows in some industries.

The calendar software paradigm has been unchanged for over a decade. The software shows the user a calendar, offers multiple views for appointments (a day view, a week view, and a month view may be made available), and allows the user to create, view and cancel appointments. Details about a meeting may also be made available.

### SUMMARY

The following presents a simplified summary of the disclosure to provide a basic understanding to the reader. This summary is not an extensive overview of the disclosure, nor does it identify key or critical elements of the claimed subject matter or define its scope. Its sole purpose is to present some concepts disclosed in a simplified form as a precursor to the more detailed description that is later presented.

Calendar management may allow scheduling, moving, or canceling appointments with incomplete information. It may be implemented using a chat-based conversational interface, natural language processing, a voice-based interface, a hybrid of chat and voice, or a display-based menu system, for example.

Calendar management may allow a user to type a request to schedule appointment invitees by name, title, email, other information, or combinations thereof, for example.

Scheduling constraints may allow users to specify rules to prevent appointments from being scheduled at times that do not work for them, even in the absence of conflicting appointments. For example, people may specify acceptable times for an appointment, as well as other times that the user considers unacceptable. Additionally, constraints may apply to all appointments, “Never schedule an appointment before 9 AM except on Thursdays,” for example. Constraints may also be applied for a particular meeting, for example, “Schedule this meeting for the end of January.” All constraints may be applied to this example of a meeting.

Equipment may have scheduling constraints, for example, on hours of use per day, number of people supported, downtime required between uses, or other limitations. Scheduling constraints may include, for example, complex rules like “ensure that all my meetings are in one block to maximize focus time” or “ensure that I have a break every 2 meetings whenever possible, and no later than every three meetings. “Do not schedule meetings before 9:00 AM where possible, but if one needs to be scheduled, ask me for approval” or may have firm rules, “allow at least five minutes travel time between meetings,” for example. Calendar management may schedule the appointment at a time that works for the organizer, invitees, and resources involved. Calendar management may be able to understand scheduling constraints and access calendars of all users and all resources using the system, which may allow it to be more effective and efficient. New invitations may be accepted, declined, or marked as tentative by a user or automatically by the system, and the system may attempt to move appointments to accommodate new invitations. Calendar management may also proactively inform a user of any conflicts. Calendar management may allow an ability to specify scheduling constraints, identify invitees with incomplete information, improve with increased usage, specify user-specific scheduling constraints, and attempt to disambiguate information by repeated interactions and conversations with the user.

### BRIEF DESCRIPTION OF THE DRAWINGS

FIG. 1 illustrates a user interface for one aspect of calendar management, according to one implementation.

FIG. 2 illustrates a user interface for one aspect of calendar management, according to another implementation.

FIG. 3 illustrates a system capable of supporting calendar management, according to one implementation.

FIG. 4 is a component diagram of a computing device configured to perform functions in accordance with calendar management, according to one implementation.

### DETAILED DESCRIPTION

Calendar Management may allow scheduling, moving, or canceling appointments with incomplete information. It may be implemented using a chat-based conversational interface, a voice-based interface, or a hybrid of chat and user interface (UI), for example. One having skill in the art will recognize that other forms of interfaces may be supported.

Calendar Management users may be either organizers of appointments or invitees, who may be participants. In addition, appointments may require the use of resources, for example, rooms, equipment, or any other resources that may have their own schedules and scheduling constraints. Appointments may be meetings, events, blocks of time a user reserves, or anything requiring scheduling.

Calendar Management may allow an organizer to initiate a request to schedule an appointment, specifying scheduling constraints and invitees and resources by name, email, or other identifying information. Calendar Management may schedule the appointment at a time that may work for the organizer, the invitees, and resources. Calendar Management's ability to understand scheduling constraints and access the calendars of all users and resources using the system may make it more effective and efficient as more users use the system or more resources are added to the system.

Scheduling constraints may allow users to specify rules to prevent appointments from being scheduled at times that do not work for them, even in the absence of conflicting appointments. For example, people may specify preferences for times to allow appointments to be scheduled, and other times that the user would prefer to exclude from appointments. Additionally, constraints may apply to a user, a resource, or globally to all appointments, “Never schedule an appointment before 9:30 AM except on Thursdays,” for example. Constraints may also be appointment-specific for a particular meeting, for example, “Schedule this meeting for the end of January.” Global, user-global, resource-global, or appointment-specific constraints may be applied to this example of a meeting. If a user requests a meeting that violates one of the constraints, for example, “Please schedule a meeting with Fred at 9:00 on Monday,” the system may confirm with “This violates your preference of not having meetings before 9.30 AM-OK to continue?” If the user responds positively, the meeting may be scheduled.

Rooms may have scheduling constraints, for example, on hours of use per day, number of people supported, downtime required between uses, or other limitations. Scheduling constraints may include, for example, complex rules like “ensure that all my meetings are in one block to maximize focus time” or “ensure that I have a 10-minute break every 2 meetings where possible and no later than every three meetings.”

Scheduling constraints may include preferences, for example, “Do not schedule before 9:00 AM unless necessary,” in which case the system may not automatically decline meetings before 9:00 AM, but may ask the user for approval. The system may allow firm rules, “allow at least five minutes travel time between meetings,” for example.

New invitations may be accepted, declined, or marked as tentative by a user or by the system automatically, and Calendar Management may attempt to move appointments to accommodate new invitations automatically. It may also proactively inform a user of any conflicts, or when preferences are violated. Calendar Management may allow an ability to specify scheduling constraints, identify invitees with incomplete information, improve with increased usage, and specify user-specific scheduling constraints.

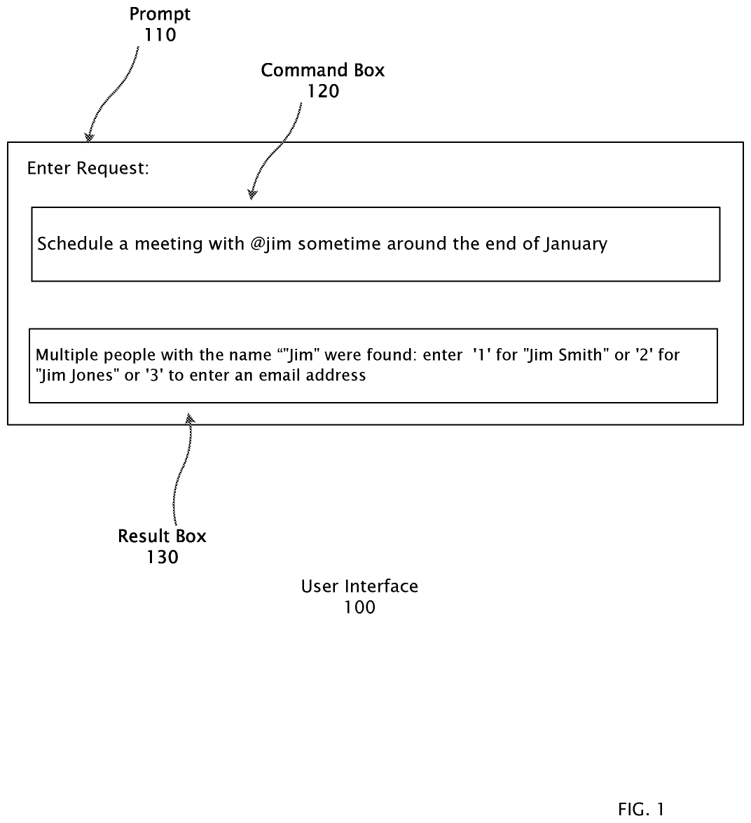

FIG. 1 illustrates User Interface 100 for one aspect of Calendar Management, according to one implementation. Calendar Management may have natural language processing capabilities and remember or determine a context for various commands. User Interface 100 may have Prompt 110, asking a user to respond with a request entered on Command Box 120. In this implementation, the user may type “Schedule a meeting with @jim sometime around the end of January,” for example. The user may specify an invitee to a meeting by using a first name, a last name, a full name, a nickname, an email address, other identifying information, or a combination thereof. The user may also be able to use an email address. Calendar Management may infer who the invitees are and ask for clarification if any of the intended invitees is unclear.

If there is more than one person with the name “Jim,” Calendar Management may respond with ‘Multiple people with the name “Jim” were found: enter ‘1’ for “Jim Smith” or ‘2’ for “Jim Jones” or ‘3’ to enter an email address,’ in Result Box 130, for example. If Calendar Management can identify the proper recipient without further information, it may return “Success” and a date and time found for the meeting. It may also confirm with the user details of the meeting just scheduled so the user can review and potentially request changes. One having skill in the art will recognize that other verbiage and user interface layouts may be used.

In another implementation, Calendar Management may not have a custom user interface. The user may type a request into an operating system command prompt, a Microsoft® Teams™ chat, or a Slack™ chat, for example, “@calbot schedule a meeting with @jim sometime around the end of January.”

Here, @calbot may be a name for Calendaring Manager. The name may be arbitrary, and organizations may choose their own names.

Here, @jim is a way to refer to a colleague with whom the meeting needs to be set up. There may be multiple people named “Jim” in the organization, in which case, the calendaring system may reply with something like:

Multiple people with the name “Jim” were found: enter ‘l’ for “Jim Smith” or ‘2’ for “Jim Jones” or ‘3’ to enter an email address.

The user may respond by typing ‘1’, ‘2’, or ‘3’.

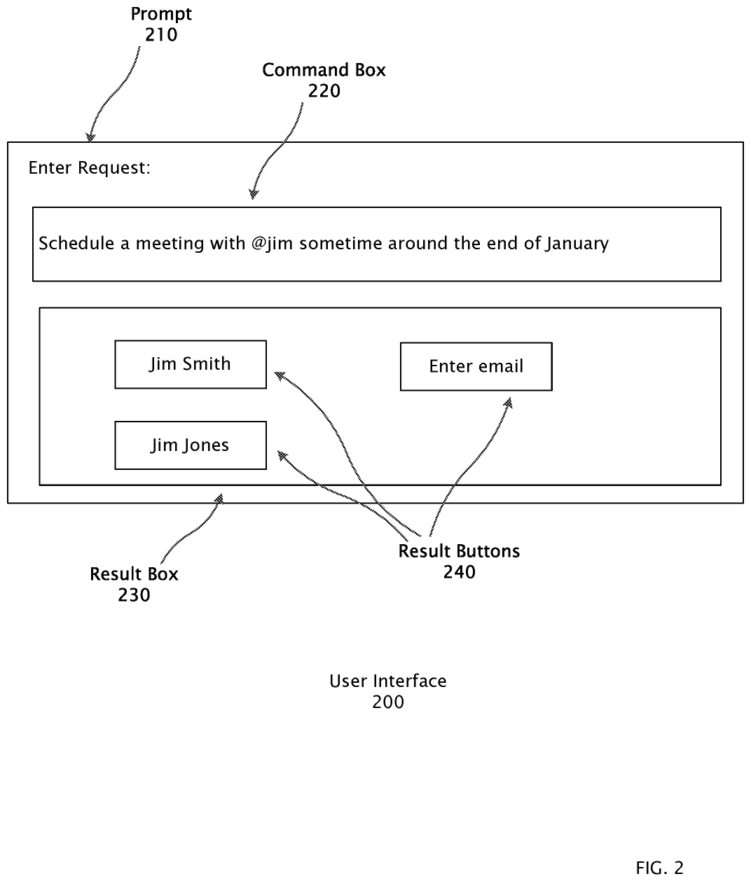

FIG. 2 illustrates User Interface 200 for one aspect of Calendar Management, according to another implementation. User Interface 200 may have Prompt 210, asking a user to respond with a request entered on Command Box 220. In this implementation, the user may type “Schedule a meeting with @jim sometime around the end of January,” for example.

If there is more than one person with the name “Jim,” Calendar Management may respond by displaying Result Buttons 240 in Result Box 230, with a button for “Jim Smith,” one for “Jim Jones,” and one to allow the user to enter an email address, for example. If Calendar Management can identify the proper recipient without further information, it may return “Success” and a date and time found for the meeting. The system may also ask for information about the meeting just scheduled so the user may review and potentially request changes. One having skill in the art will recognize that various verbiage and user interface layouts may be used.

When the user specifies that the meeting with @jim needs to be around the end of January, the system may remember this information, referred to as a “scheduling constraint,” and schedule the meeting at a time that works for both the user and Jim.

If Jim has no available slot at the end of January, but Jim uses the same calendaring system, then the calendaring system will have access to Jim's calendar and will know the scheduling constraints Jim has specified. The system may then automatically move appointments on Jim's calendar to make space for the meeting at the end of January and optionally notify Jim that appointments have moved.

Having scheduling constraints may allow Calendar Management to move appointments when scheduling conflicts occur. A user may be able to specify a range or list of times for an appointment. For example, if a second appointment that conflicts with a scheduled appointment comes up later, Calendar Management may automatically move the scheduled appointment to another time, knowing that any time end of January is acceptable to the user.

Calendar Management may get better and more effective as more people use it. If everybody in an organization uses this system, Calendar Management may access everybody's “scheduling constraints” and move things around automatically.

Calendar Management may use natural language processing to allow entering scheduling constraints for a user, rather than for an appointment, which may include rules like “maximize focus time,” “prefer meetings in the afternoon, not morning,” or “put in a 15 minute break after every 2 hours of meetings,” for example.

In another implementation, Calendar Management may use a limited vocabulary rather than natural language processing, which may remove ambiguities from commands.

When an invitation arrives, Calendar Management may allow a user to accept or decline the invitation, or it may do so automatically. It may either ask the user as new invitations arrive or batch them at a specific time, for example, which may be specified by the user. For example, a user may state that new invitations must only be surfaced to them at the end of the day unless it is an urgent meeting for that day itself. In that case, the system may display, for example: “You have two new meetings on your calendar awaiting your attention: “All Hands Meeting” on January 28, 1-2 PM (accept/decline/tentative),” “Followup on Spelling Bee” on January 17, 4 PM (accept/decline/tentative).”

The user may have a chance to respond with accept, decline, tentative, or ask for a new time, for example: “Please see if “Followup” meeting on January 17 can be moved to the AM sometime after 9.” Note how only part of the title has been specified.

If a meeting is scheduled with someone in a different time zone and whether it is a morning or evening meeting is not specified, the system may ask whether the time specified is meant to be AM or PM. For example, if the system knows that John is in India, and a user asks to set up a meeting with John at 7:00, the system may ask whether the user means 7:00 AM or 7:00 PM.

Note again that in proposing a new time for the “Followup on Spelling Bee” meeting, the system may allow the user to specify incomplete information; in this example, the meeting title is incomplete, and the new proposed time is a range of times. Other examples may include the user may telling Calendar Management, “Please move the meeting on January 17 at 1 PM to the AM,” without referring to the meeting title, or “Please move meeting with Jim at end of January to earlier that week in the afternoon,” where neither the meeting title nor time is referred to; the meeting is referred to by referring to the invitee and a rough time period. If a user refers to the meeting with an incomplete title or approximate meeting time, the system may attempt to infer the specific meeting being referred to automatically.

In addition, when invitations to new appointments conflict with the user's calendar, Calendar Management may attempt to move an appointment to accommodate the new invitation automatically. If it is unable to adjust the appointment, the system may send a message to the user informing them of a conflict they must manually resolve. For example, “A new ‘All Hands’ meeting has arrived and conflicts with your meeting with Jim. Do you want to 1) accept the All Hands and move the meeting with Jim, 2) decline, 3) ask an organizer for a new time, or 4) mark your attendance as tentative?”

Various user interfaces may allow the user to respond by entering a number, using a chat interface, voice recognition, a programmatic interface (API), or clicking buttons. One having skill in the art will recognize that many different types of user interfaces may be used.

Alternatively, the system may send a list of important meetings in a time period to the user, for example, meetings today, meetings in the next week, or meetings in the next month. For example, the system may also send the user a list of particular recurring meetings.

The user may also type a short command to the system to ask for upcoming meetings and conference rooms, for example: “Tell me what rooms I need to be in for the next two hours.”

Calendar Management may proactively inform a user of conflicts when they arise and may allow the user to ask where they need to be in the next few hours or at a given time. It may allow the user to refer to meetings using incomplete information about meeting time, title, or invitees.

Similar techniques may be used to allow a user to move or cancel meetings with incomplete information. One may say things such as: “Move all my Wednesday afternoon meetings to new times and decline if new times cannot be found. Confirm any declines with me before proceeding.”

In this case, Calendar Management will attempt to move the Wednesday afternoon meetings to new times and, if new times cannot be found, will notify the user asking which ones they wish to decline or cancel.

In many organizations, meeting rooms are in short supply. Peak hours often have a lot of demand for meeting rooms. Some demand at peak hours may be artificial; people may use peak hours for meetings even though scheduling constraints for those meetings may allow for meetings to occur at off-peak hours. Using such a system may allow finding meeting rooms by spreading meetings to non-peak hours because people have put in broad scheduling constraints.

A user may specify scheduling constraints of the form “I prefer meetings before 5:00 PM but can take a meeting 5:00 PM-6:00 PM if needed”. This flexibility may allow the system to favor a meeting before 5:00 PM, but it can pick the 5:00 PM-6:00 PM slot if needed. In other words, scheduling constraints may have a range of preferences and need not just be what works and what doesn't work.

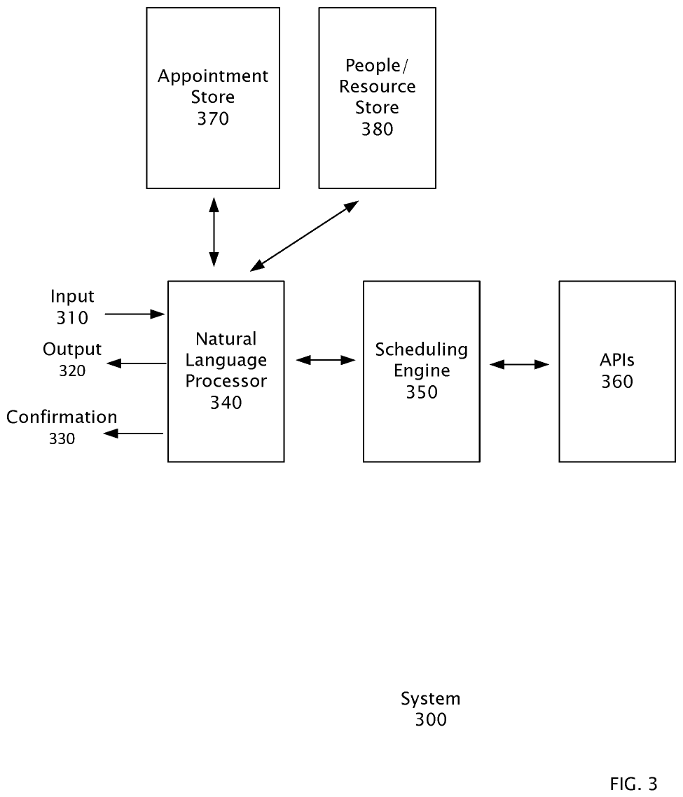

FIG. 3 illustrates a system capable of supporting Calendar Management, according to one implementation.

Natural Language Processor 340 may receive Input 310, which may include a command, a reference to a meeting, or a reference to a person. It may determine from that input what the command is, which meeting it applies to, and which person is being referenced.

For example, if the command is “change my meeting on Friday morning with @jim to Monday,” Natural Language Processor 340 may access Appointment Store 370 and People and Resource Store 380 to determine which meeting is referenced based on the meeting time, invitees' schedules, and availability of resources. For example, if several meetings are scheduled on Friday morning, and several people are named “Jim” in the system, but there is only one meeting on Friday with one Jim, Natural Language Processor may determine that is the meeting referenced. Output 320 may prompt for further information to identify the meeting if needed. Natural Language Processor 340 may communicate with Scheduling Engine 350, which may schedule the meeting for Monday if both participants are available. If not, it may check for another day and time that would work and schedule the meeting for then, sending Confirmation 330 to the organizer that submitted the command to verify that the new time is suitable.

People and Resource Store 380 may include information about people within an organization, including names, email addresses, organization charts, and other information necessary for Calendar Management. Resource information may include capacity of rooms, service duty cycle for equipment, or other information.

Appointment Store 370 may hold appointment information for Calendar Management.

APIs 360 may allow Calendar Management to access other software, such as Slack or Microsoft Teams, as well as email and personal calendaring software, Outlook, Gmail, and Google Calendar, for example.

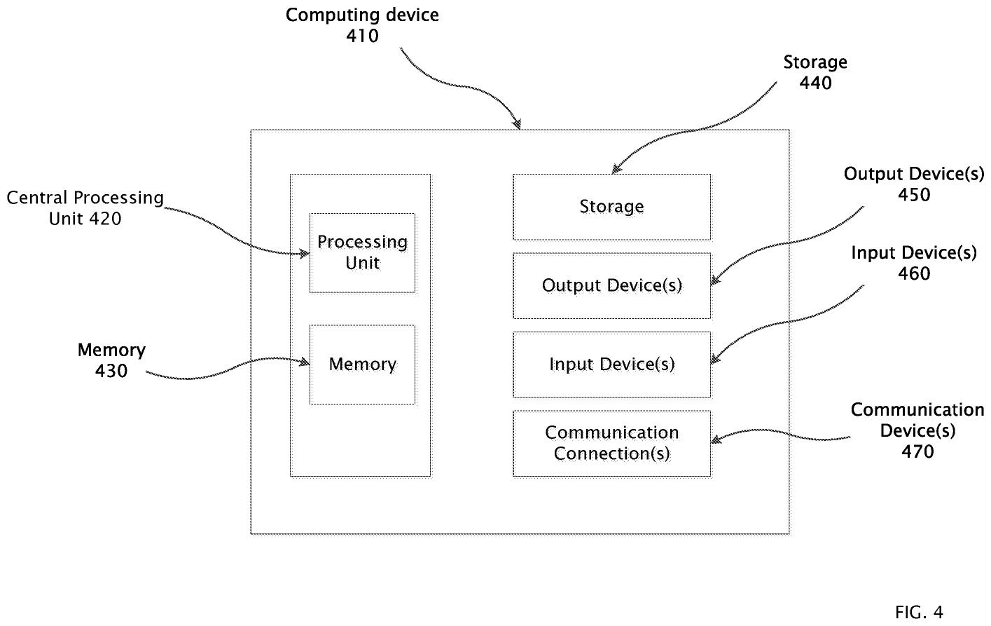

FIG. 4 is a component diagram of a Computing Device 410 configured to perform functions in accordance with Calendar Management, according to one implementation. Computing Device 410 can be utilized to implement one or more computing devices, computer processes, or software modules described herein, including, for example, but not limited to, a mobile device. In one example, Computing Device 410 can be used to process calculations, execute instructions, and receive and transmit digital signals. In another example, Computing Device 410 can be used to process calculations, execute instructions, receive and transmit digital signals, receive and transmit search queries and hypertext, and compile computer code suitable for a mobile device. Computing Device 410 can be any general or special purpose computer now known or to become known capable of performing the steps or performing the functions described herein, either in software, hardware, firmware, or a combination thereof.

In its most basic configuration, Computing Device 410 typically includes at least one Central Processing Unit (CPU) 420 and Memory 430. Depending on the exact configuration and type of Computing Device 410, Memory 430 may be volatile (such as RAM), nonvolatile (such as ROM, flash memory, etc.), or some combination of the two. Additionally, Computing Device 410 may also have additional features/functionality. For example, Computing Device 410 may include multiple CPUs. The described methods may be executed in any manner by any processing unit in Computing Device 410. For example, the described process may be executed by multiple CPUs in parallel.

Computing Device 410 may also include additional storage (removable or non-removable) including, but not limited to, magnetic or optical disks or tape. Such additional storage is illustrated by Storage 440. Computer-readable storage media includes volatile and nonvolatile, removable and non-removable media implemented in any method or technology for storage of information such as computer-readable instructions, data structures, program modules, or other data. Memory 430 and Storage 440 are all examples of computer-readable storage media. Computer-readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which may be by Computing Device 410. Any such computer-readable storage media may be part of Computing Device 410. But computer-readable storage media does not include transient signals.

Computing Device 410 may also contain Communications Device(s) 470 that allow the device to communicate with other devices. Communications Device(s) 470 is an example of communication media. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media. The term computer-readable media, as used herein, includes both computer-readable storage media and communication media. The described methods may be encoded in any computer-readable media in any form, such as data, computer-executable instructions, and the like.

Computing Device 410 may also have Input Device(s) 460, such as a keyboard, mouse, pen, voice input device, touch input device, etc. Output Device(s) 450, such as a display, speakers, printer, etc., may also be included. All these devices are well known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed or execute some software instructions at the local terminal and some at the remote computer (or computer network). Those skilled in the art will also realize that by utilizing conventional techniques known to those skilled in the art that all or a portion of the software instructions may be carried out by a dedicated circuit, such as a digital signal processor (DSP), programmable logic array, or the like.

While the detailed description above has been expressed in terms of specific examples, those skilled in the art will appreciate that many other configurations could be used. Accordingly, it will be appreciated that various equivalent modifications of the above-described implementations may be made without departing from the spirit and scope of the invention.

Additionally, the illustrated operations in the description show appointments occurring in a particular order. In alternative implementations, certain operations may be performed in a different order, modified, or removed. Moreover, steps may be added to the above-described logic and still conform to the described implementations. Further, operations described herein may occur sequentially, or certain operations may be processed in parallel. Yet further operations may be performed by a single processing unit or by distributed processing units.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples, and data provide a complete description of the manufacture and use of the invention. Since many embodiments of the invention can be made without departing from the spirit and scope of the invention, the invention resides in the claims hereinafter appended.

1. A system for calendar management, comprising:
a processor;
a memory coupled to the processor; the memory containing:
code that, when executed on the processor, provides:
a user interface, configured to accept a command and display results of executing the command;
a natural language processor, configured to receive a command from the user interface and return a result to the user interface;
a scheduling engine, configured to access an appointment store and a people store to determine a specific time that will work for an appointment based on appointments for invitees, resources, organizers, and scheduling constraints;
data, comprising:
a first store, configured to store information about appointments, including time, invitees, resources, and organizers;
a second store, configured to store information about people, including email addresses and names;
a third store with information about a first set of scheduling constraints for appointments;
a fourth store with information about a second set of scheduling constraints for people; and
a fifth store with information about a set of scheduling constraints for resources.

2. The system of claim 1, wherein at least one of the scheduling constraints in the first set of scheduling constraints comprises rules which apply to a specific appointment.

3. The system of claim 1, wherein at least one scheduling constraint in the first set of scheduling constraints or at least one scheduling constraint in the second set of scheduling constraints, refers to a range of acceptable and unacceptable times for an appointment.

4. The system of claim 1, wherein the first store, the second store, the third store, the fourth store, and the fifth store may be in the same or different storage devices in any combination.

5. The system of claim 1, whereby the system can adjust appointment times using scheduling constraints in the first set combined with scheduling constraints in the second set of scheduling constraints that specify a range of acceptable and unacceptable times for appointments when there are multiple invitees of the appointments.

6. The system of claim 1, wherein the natural language processor works with the appointment store, the people store, the scheduling engine, or a combination thereof, to schedule an appointment when incomplete information is provided.

7. The system of claim 1, wherein at least one of the scheduling constraints in the first set of scheduling constraints comprises rules which apply to a plurality of appointments.

8. The system of claim 1, wherein at least one of the scheduling constraints in the second set of scheduling constraints comprises rules specifying a maximum number of hours of appointments per day.

9. The system of claim 1, wherein at least one of the scheduling constraints in the second set of scheduling constraints comprises rules specifying a number of breaks between multiple appointments for a user.

10. The system of claim 1, wherein at least one of the scheduling constraints in the second set of scheduling constraints comprises rules specifying a minimum break time after multiple appointments for a user.

11. The system of claim 1, wherein at least one of the scheduling constraints in the second set of scheduling constraints comprises rules specifying a minimum travel time between two appointments for at least one invitee, the minimum travel time based on a location of each appointment.

12. A method for having an appointment, comprising:
receiving a command requesting an appointment by a natural language processor that interfaces with a scheduling engine, the scheduling engine:
accessing an appointment store comprising information about existing appointments, including time, invitees, resources, organizers, and scheduling constraints;
accessing a people store, comprising information about people, including email addresses, names;
returning a scheduled time and date for that appointment that works for the invitees, resources, organizers, and the scheduling constraints; and
having the appointment at the time and date.
